(19) United States
(12) Patent Application Publication
(10) Pub. No.: US 2010/0116212 A1
(43) Pub. Date: May 13, 2010

(54) TUBE ARRANGEMENT

(75) Inventor: Jan Kassibrahim, Stockholm (SE)

Correspondence Address: YOUNG & THOMPSON, 209 Madison Street, Suite 500, Alexandria, VA, 22314, US

(73) Assignee: DELAVAL HOLDING AB, TUMBA (SE)

(21) Appl. No.: 12/598,615

(22) PCT Filed: Apr. 30, 2008
(86) PCT No.: PCT/SE2008/050500

§ 371 Date: Nov. 3, 2009

(30) Foreign Application Priority Data
May 3, 2007 (SE) 0701064-8

(51) Int. Cl. A01J 5/00; F16L 9/00

(52) U.S. Cl. 119/14.03; 138/111

(57) ABSTRACT

A tube arrangement arrangement includes a first tubular element (18) having an inner channel (19) adapted to transport milk and a second tubular element (20) having two inner channels (21a, b) adapted to transport air with a pulsating vacuum pressure. A peripheral surface of the first tubular element (18) has an area (24a) with a substantially complementary shape to an area (25a) of the peripheral surface of the second tubular element (20). The complementary areas (24a, 25a) include fastening elements adapted to releasably connect the complementary shaped areas (24a, 25a) of the first tubular element (18) and the second tubular element (20) to each other.

### THE BACKGROUND OF THE INVENTION AND PRIOR ART

The present invention relates to a tube arrangement comprising a first tubular element, which has a peripheral surface and an inner channel adapted to transport milk, and a second tubular element, which has a peripheral surface and at least one inner channel adapted to transport air with a pulsation vacuum pressure.

In a milking stall, the long milk tube and the long pulse tubes have an extension in parallel towards a claw of a milking member. In certain cases, one or several electric cables also have an extension in parallel with these tubes. It is known to hold such parallel tubes and electric cables in a connected state by means of a number of holding members. The holding member can be flexible annular elements of, for example, silicone. Inevitably, such a bundle of tubes and cables obtains an irregular outer surface with cavities and gaps between adjacent tubes and cables. During the attachment process and the removing process of the milking member, the bundle of tubes provides a motion in relation to a cow and plural components in the milking stall. If the bundle of tubes comes in contact with, for example, the hooves of the cow or a protruding portion of a component during such a motion, there is a risk that the bundle gets caught in the cow or the component. There is also a risk that dirt is collected in cavities and gaps between adjacent tubes in such a bundle. Furthermore, if the long milk tube and the long pulse tubes get twisted, there is a risk that the cluster will not hang freely under the udder of a milking animal during the milking process.

DK 94 00044 U3 shows a flexible hose comprising three integrated parts in the form of a centre part and two side parts located on the opposite sides of the centre part. A milk channel is provided in the centre part and each side parts is provided with a pulse vacuum channel. However, if one of the including parts of the flexible hose will be damaged, the entire hose must be exchanged.

### SUMMARY OF THE INVENTION

The object of the present invention is to provide a tube arrangement comprising a first tubular element for transportation of milk and a second tubular element for transportation of air with a pulsating vacuum pressure, which tubular elements have a design such that it is easy to remove a damaged tubular element in the tube arrangement and replace it by a new one.

This object is achieved in that the peripheral surface of the first tubular element has an area with a substantially complementary shape to an area of the peripheral surface of the second tubular element and in that said complementary areas comprise fastening means adapted to releasably connect said complementary shaped areas of the first tubular element and the second tubular element to each other. Since the tubular elements have peripheral surfaces with complementary shaped areas, it is possible to arrange the tubular elements very close to each other in a connected state. Thereby, the tube arrangement obtains a small cross section area. By providing the complementary areas of the respective tubular elements with a releasable fastening means, it is possible to hold the tubular elements close together in a connected state at the same time as it is possible to remove a damaged tubular element in the tube arrangement and replace it by a new one. It is not necessary to exchange the entire tube arrangement if one of the tubular elements in the tube arrangement will be damaged. Such releasable fastening means may be an adhesive having releasable properties, a double-sided tape, a Velcro tape etc. Normally, the second tubular element has two inner channels adapted to transport air with a pulsating vacuum pressure. However, in certain applications, the second tubular element can have another number of inner channels such as, for example, one or four.

According to a preferred embodiment of the invention, the fastening means comprises a snap-fit connection between a part of the complementary area of the first tubular element and a part of the complementary area of the second tubular element. By the use of a snap-fit connection, it is possible to remove a damaged tubular element in a very quick and easy manner and replace it by a new one. The snap-fit connection may have a design such that mutual motions between the first tubular element and the second tubular element are allowed in a length direction of the tube arrangement. Such mutual motions between the tubular elements make it easier to bend the tube arrangement. Another advantage is that the tubular elements can be manufactured of relatively stiff elastic materials. By the use of a stiff elastic material in the tubular elements, the risk that the walls of the channels in the respective tubular elements are collapsed during loads, and thus the risk that the flow through the channels is stopped up, is considerably reduced.

According to a further preferred embodiment of the invention, the snap-fit connection comprises a protruding portion of one of the tubular elements and a recessed portioned portion of the other tubular element, wherein the protruding portion is adapted to be releasably locked into the recessed portion when the tubular elements are in a connected state. The protruding portion may comprise two resilient legs provided with locking surfaces adapted to come in engagement with locking surfaces of the recessed portion when the tubular elements are in a connected state. During a connecting motion of the legs into the recessed portion, the legs are pressed together by means of its resilient properties. When the legs have reached a locking position into the recessed portion, they will expand such that the locking surfaces come in engagement with the locking surfaces of the recessed portion.

According to a further preferred embodiment of the invention, the locking surfaces of the resilient legs and the locking surfaces of the recessed portion have an inclination such that it is possible to release the tubular elements from each other by applying a separating force of a predetermined value between the tubular elements in a releasing direction. The locking surfaces can be dimensioned such that said separating force is of a value such that the tubular elements do not risk coming loose from each other by mistake and such that it is possible to release the tubular elements from each other manually or by means of a tool. Advantageously, the protruding portion comprises guiding surfaces adapted to come in contact with surfaces of the recessed portion during an insertion motion of the protruding portion into the recessed portion. By means of said guiding surfaces, the protruding portion can be inserted into the recessed portion in a relatively quick and simple manner. The second tubular element may comprise an intermediate part and two side parts each comprising one inner channel of the second tubular element, wherein the intermediate part comprises said recessed portion. Such a design of the second tubular element makes it possible to provide a symmetric second tubular element with a centrally located recessed portion.

According to a further preferred embodiment of the invention, the first tubular element and/or the second tubular element comprise a passage having an extension from a peripheral surface to an inner space adapted to receive at least one conduit element. Thereby, it is possible to insert a separate conduit element of a suitable kind, such as an electric conduit element, through the passage and into the inner space of the tubular element. The risk that such a conduit element is caught in external objects during motions of the tube arrangement is eliminated. The inner space may have an extension between openings of end surfaces of the first tubular element or the second tubular element. Thereby, the conduit element may be threaded into the inner space from one of the end openings. The first tubular element and/or the second tubular element may comprise a passage having an extension from a complementary peripheral surface of the tubular element to said inner space. In this case, the conduit element must be inserted into the inner space before the first tubular element and the second tubular element are connected to each other. However, the passage to the inner space is completely covered by the tubular elements when they are connected to each other. Furthermore, it is possible to demount and exchange the first tubular element or the second tubular element of the tube arrangement without dismounting an electric conduit element from its end connections in connecting components. Thereby, the exchanging process may be performed in a very quick manner.

According to a further preferred embodiment of the invention, the passage and the inner space are located between the legs of the first tubular element. The conduit element obtains here a very safe position inside the tube arrangement when the first tubular element and the second tubular element are in a connected state. Furthermore, the existence of the passage and the inner space creates a space between the legs. This space makes it possible for the legs to be pressed together during the insertion motion of the legs into the recessed part.

According to a further preferred embodiment of the invention, a part of the peripheral surfaces of the first tubular element and a part of the peripheral surfaces of the second tubular element are adapted to form the outer peripheral surface of the tube arrangement when the first tubular element and the second tubular element are in a connected state. Consequently, the remaining parts of the peripheral surfaces of the first tubular element and the second tubular element, which not are complementary shaped and in contact with each other in a connected state, form the outer peripheral surface of the tube arrangement. Preferably, the outer area of the first tubular element forms at least partly a convex outer surface of the tube arrangement when the first tubular element and the second tubular element are in a connected state. It is very unlikely that such a shaped outer surface of a tubular element get caught in a surrounding object.

The outer area of the second tubular element may also form at least partly a convex outer surface of the tube arrangement when the first tubular element and the second tubular element are in a connected state. Preferably, the tubular elements have such shaped outer surfaces along at least a main part of its length. Advantageously, the outer area of the first tubular element and the outer area of the second tubular element have a design such that the tube arrangement in a limit zone between said areas obtains a smooth transition. Thereby, it is possible to give the whole tube arrangement a substantially convex and smooth outer surface. The risk that the tube arrangement gets caught in surrounding objects during motions of the tube arrangement is low. Furthermore, it is easy to keep a tube arrangement with such an outer surface free from dirt.

According to a further preferred embodiment of the invention, the first tubular element is manufactured of a material having elastic properties. Such a first flexible tubular element is bendable in desired directions. Preferably, the second tubular element is also manufactured of a material having elastic properties. Thereby, it is possible to bend the tube arrangement in a connected state in desired directions. The tubular elements can be manufactured of a thermoplastic elastomer TPE, polypropen PP, silicone or rubber. The first tubular element and the second tubular element may be manufactured of materials having different elastic properties. Thereby, it is possible to give certain parts of the tube arrangement more flexibility than other parts. It is also possible to manufacture the individual tubular elements in different kinds of materials having different properties in order to further give the tube arrangement desired properties.

The invention is also directed to a milking stall comprising such a tube arrangement. The tube arrangement can here replace the conventional long milk tube and the long pulse tubes which have an extension in parallel towards a milking member attachable to an animal to be milked. In a milking stall provided with a compact modular unit, the tube arrangement may have an extension from the compact modular unit to the milking member. Alternatively, tube arrangement can be connected to a teat cup. In this case, the second tubular element has one inner channel adapted to transport air with a pulsation vacuum pressure. However, it is also possible to use the tube arrangement in other positions in a milking stall where milk and a pulsation vacuum pressure are transported in parallel.

### BRIEF DESCRIPTION OF THE DRAWINGS

The present invention is now to be explained more closely by means of a preferred embodiment, which is disclosed as an example, and with reference to the attached drawings.

FIG. 1 shows a part of a milking stall comprising a tube arrangement according to the invention,

FIG. 2 shows a cross-section view of the tube arrangement with including tubular elements in a connected state and

FIG. 3 shows a cross-section view of the tube arrangement with including tubular elements in a separated state.

### DETAILED DESCRIPTION OF A PREFERRED EMBODIMENT OF THE INVENTION

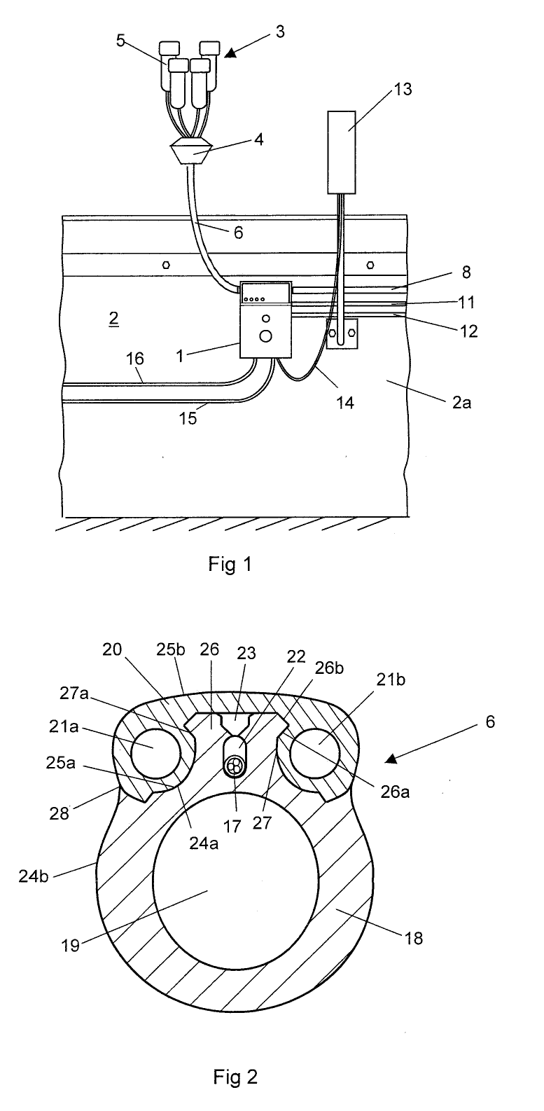

FIG. 1 shows a part of a milking stall for milking of cows. The milking stall comprises a compact modular unit 1 mounted on a wall surface 2a of a pit 2. The milking stall comprises a milking member in the form of a cluster 3, which comprises a claw 4 and four teat cups 5. Each teat cup 5 is connected to the claw 4 by means of a short milk tube and a short pulse tube. However, the four short pulse tubes have not been indicated in the figure. A tube arrangement 6 has an extension between the claw 4 of the milking member 3 and the compact modular unit 1.

The milking stall comprises a milk pipeline system having the function to transport milk from a cow in the milking stall to a milk-collecting container. The milk pipeline system is, in a conventional manner, connectable to a vacuum source for the transportation of the milk. The milk is transported from the respective teat cups 5, via the short milk lines, the claw 4 and the tube arrangement 6 to the compact modular unit 1. A milk tube 8 conducts the milk from the compact modular unit 1 towards said milk-collecting container. A not visible milk meter is mounted in an inner space of the compact modular unit 1 for measuring of the milk flow through the compact modular unit 1.

Further, the milking stall comprises a vacuum pipeline system which is adapted to supply a pulsating vacuum to the teat cups 5 during a milking process of an animal. The vacuum pipeline system comprises a not visible pulsator mounted in the inner space of the compact modular unit 1. The pulsator is adapted to supply the pulsating vacuum, via the tube arrangement 6, the claw 4 and the short pulse tubes, to a pulsating chamber of the respective teat cups 5. In order to accomplish said pulsating vacuum, the pulsator is connected to a vacuum tube 11 and a fresh air tube 12.

The milking stall comprises a not visible electric control unit mounted in the inner space of the compact modular unit 1. The electric control unit is arranged to control and supervise the milking processes in the milking stall. Consequently, the electric control unit has the function to control several systems used in the milking stall, such as the milk pipeline system, the vacuum pipeline system and a schematically indicated remover 13. The remover 13 has the function to remove the cluster 5 from the cow when a milking process is finished in the milking stall. The control unit controls the remover 13 by means of an electric signal line 14. The electric control unit may also have the function to communicate with a main control system for a plurality of milking stalls. Therefore, an electric cable in the form of an electric signal line 15 is connected to the compact modular unit 1. Furthermore, the electric control unit is connected to an electric power source via an electric cable 16. In certain cases, one or several electric cables 17 have to have an extension from the control unit in the compact modular unit 1 to the claw 4 of the milking member 3. Such an electric cable 17 is possible to arrange inside the tubular arrangement 6.

FIG. 2 shows a cross section view of the tube arrangement 6 in FIG. 1. The tube arrangement 6 comprises a first tubular element 18 having an inner channel 19 adapted to transport milk and a second tubular element 20 having two inner channels 21a, b adapted to transport air with a pulsation vacuum pressure. The milk channel 19, which is dimensioned to transport milk from the claw 4 to the compact modular unit 1, has a relatively large cross section area. The two vacuum pulse channels 21a, b, which are dimensioned to transport pulsating vacuums from the claw 4 to the compact modular unit 1, have smaller cross section areas than the milk channel 19. The first tubular element 18 comprises a passage 23 and a relatively small inner space 22 adapted to receive at least one electric cable 17. The first tubular element 18 and the second tubular element 20 are manufactured of materials having elastic properties. Such materials can be a thermoplastic elastomer TPE, polypropen PP, silicone and rubber. The first tubular element 18 and the second tubular element 20 can be manufactured of the same elastic material or of different elastic materials. Each of the first tubular element 18 and the second tubular element 20 can also be manufactured of different kinds of elastic materials.

The first tubular element 18 has a peripheral surface 24a, b and the second tubular element 20 has a peripheral surface 25a, b. An area 24a of the peripheral surface of the first tubular element 18 has a substantially complementary shape to an area 25a of the peripheral surface of the second tubular element 20. The first tubular element 18 comprises a protruding portion formed by two resilient legs 26. The legs 26 can have an extension along the whole first tubular element or be arranged with suitable intervals in suitable positions along the extension of the first tubular element. Each leg 26 is provided with a locking surface 26a and a guiding surface 26b. The passage 23 and the inner space 22 consist a space between the legs 26, which makes it possible for the legs to be pressed together. The complementary area 25a of second tubular element 20 comprises a recessed portion 27 having a substantially complementary shape to the legs 26 of the first tubular element 18. The recessed portion 27 is arranged in a part of the second tubular element 20 located between two side parts comprising the respective channels 21a, b. The recessed portion 27 has a widened part in the vicinity of a bottom surface. The widened part comprises locking surfaces 27a adapted to come in engagement with the locking surfaces 26a of the legs 26 when the first tubular element 18 and the second tubular element 20 are in a connected state. In an unloaded state, the legs 26 take up a wider space than the width of certain parts of the recessed portion 27. However, due to the resilient properties of the legs 26 and their guiding surfaces 26b, it is easy to insert the resilient legs 26 into the recessed portion 27. The legs 26 expand in a widened bottom part of the recessed portion 27 such that the locking surfaces 26a, 27a of the legs 26 and the recessed portion 27 come in engagement with each other and form a snap-fit connection which holds the first tubular element 18 and the second tubular element 20 releasably connected to each other.

When the first tubular element 18 and the second tubular element 20 are in the connected state, a remaining area 24b of the peripheral surface of the first tubular element 18 and a remaining area 25b of the peripheral surface of the second tubular element 20 form the outer surface of the tube arrangement 6.

The outer area 24b of the first tubular element 18 forms a substantially smooth substantially convex outer surface of the tube arrangement 6. The outer area 25b of the second tubular element 20 also forms a substantially convex outer surface of the tube arrangement 6. The outer area 24b of the first tubular element 18 and the outer area 25b of the second tubular element 20 have a design such that the tube arrangement 6 in a limit zone 28 between said areas 24b, 25b obtains a smooth transition. As a consequence, the entire tube arrangement 6 obtains a smooth outer surface in a connected state.

Preferably, the first tubular element 18 and the second tubular element 20 have the same cross section area along their entire length. Thereby, it is possible for the first tubular element 18 and the second tubular element 20 to provide mutual motions in relation to each other in a longitudinal direction of the tube arrangement 6. Such mutual motions between the first tubular element 18 and the second tubular element 20 can, for example, be provided when the tube arrangement is bent.

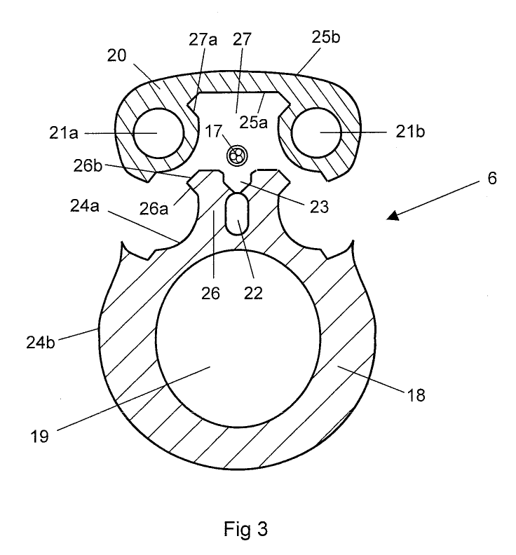

FIG. 3 shows the tubular elements 18, 20 and the electric cable 17 of the tube arrangement 6 in a separated state. The connection process of the separate parts 17, 18, 20 is performed in the following manner. Initially, the electric cable 17 is inserted into the passage 23 and is pressed into the space 22 of the first tubular element 18. The passage 23 and the space 22 have an extension along the whole length of the first tubular element 18. Thereafter, the first tubular element 18 and the second tubular element 20 are pressed together such that their complementary shaped surfaces 24a, 25a are moved against each other. The legs 26 of the first tubular element 18 are moved into the recessed portion 27 of the second tubular element 20 during this motion. The guiding surfaces 26b of the legs 26 have an inclination in relation to the walls of the recessed portion 27 which presses the legs 26 together and possibly widen the recessed portion 27. Thereby, it is easy to insert the legs 26 of the first tubular element 18 into the recessed portion 27 of the second tubular element with a predetermined force. When the legs 26 reach the widened bottom of the recessed portion 27, the legs 26 are expanded and the locking surfaces 26a of the legs and the locking surfaces 27a of the recessed portion 27 come in engagement with each other. A snap-fit connection is provided which holds the first tubular element 18 and the second tubular element 20 together in a releasable manner. In this state, the second tubular element 20 closes the passage 23 to the inner space 22. As a consequence, the electric cable 17 obtains a very safe position inside the inner space 23 in the closed state of the tube arrangement.

During the attachment process of the milking member 3 to a cow and the removing process of the milking member 3 from a cow, the tube arrangement 6 provides a motion in relation to the cow and several components in the milking stall. Thereby, the tube arrangement 6 risks coming in contact with the cow and said components. Since the tube arrangement 6 has a smooth and substantially convex outer surface along its whole length, the risk that the tube arrangement 6 gets caught in, for example, the hooves of the cow or a part of said components in the milking stall during the attachment process and the removing process of the milking member 3 is substantially negligible. Furthermore, the smooth surface of the tube arrangement 6 is free from pockets and cavities in which dirt can get caught.

If one of the tubular elements 18, 20 is damaged, it is very easy to release and exchange a damaged tubular element 18, 20 by a new one. If one of the tubular elements has to be exchanged, the respective tubular elements 18, 20 are gripped and a separating force is supplied in a releasing direction of the tubular elements 18, 20. The locking surfaces 26a of the legs and the locking surfaces 27a of the recessed portion 27 have an inclination in relation to the releasing direction such the legs 26 are pressed together by the supplied force. When the force obtains a predetermined value, the legs are in a pressed together state such that they can be drawn out from the recessed portion. Thereafter, a new one can replace the damaged tubular element.

The invention is not restricted to the described embodiments disclosed in the figures, but may be varied freely within the scope of the claims. The second tubular element can, for example, have an arbitrary numbers of inner channels. The tube arrangement can be used in arbitrary applications where milk and a pulsation vacuum pressure are transported in parallel.

1. A tube arrangement comprising a first tubular element (18), which has a peripheral surface (24a, b) and an inner channel (19) adapted to transport milk, and a second tubular element (20), which has a peripheral surface (25a, b) and at least one inner channel (21a, b) adapted to transport air with a pulsating vacuum pressure, characterised in that the peripheral surface of the first tubular element (18) has an area (24a) with a substantially complementary shape to an area (25a) of the peripheral surface of the second tubular element (20) and in that said complementary areas (24a, 25a) comprise fastening means adapted to releasably connect said complementary shaped areas (24a, 25a) of the first tubular element (18) and the second tubular element (20) to each other.

2. A tube arrangement according to claim 1, characterised in that the fastening means comprises a snap-fit connection between a portion (26) of the complementary area (24a) of the first tubular element (18) and a portion (27) the complementary area (25a) of the second tubular element (20).

3. A tube arrangement according to claim 2, characterised in that the snap-fit connection has a design such that mutual motions between the first tubular element (18) and the second tubular element (20) are allowed in a length direction of the tube arrangement.

4. A tube arrangement according to claim 2, characterised in that the snap-fit connection comprises a protruding portion (26) of one of the tubular elements (18) and a recessed portion (27) of the other tubular element (20), wherein the protruding portion (26) is adapted to be releasably locked into the recessed portion (27) when the tubular elements (18, 20) are in a connected state.

5. A tube arrangement according to claim 4, characterised in that the protruding portion comprises two resilient legs (26) provided with locking surfaces (26a) adapted to come in engagement with locking surfaces (27a) of the recessed portion (27) for releasably locking the protruding portion (26) into the recessed portion (27).

6. A tube arrangement according to claim 5, characterised in that the locking surfaces (26a) of the resilient legs (26) and the locking surfaces (27a) of the recessed portion (27) have an inclination such that it is possible to release the tubular elements (18, 20) from each other by applying a separating force of a pre-determined value between the tubular elements (18, 20) in a releasing direction.

7. A tube arrangement according to claim 4, characterised in that the protruding portion comprises guiding surfaces (26b) adapted to come in contact with wall surfaces of the recessed portion (27) for guiding the protruding portion (26) into the recessed portion (27) during an insertion motion.

8. A tube arrangement according to claim 3, characterised in that the second tubular element (20) comprises an intermediate part and two side parts each comprising one inner channel (21a, b) of the second tubular element (20), wherein the intermediate part comprises said recessed portion (27).

9. A tube arrangement according to claim 5, characterised in that the first tubular element (18) and/or the second tubular element (20) comprise a passage (23) having an extension from a peripheral surface (24, 25) of the tubular element (18, 20) to an inner space (22) adapted to receive at least one conduit element (17).

10. A tube arrangement according to claim 9, characterised in that the first tubular element (18) and/or the second tubular element (20) comprise a passage (23) having an extension from a complementary peripheral surface (24a, 25a) of the tubular element (18, 20) to said inner space (22).

11. A tube arrangement according to claim 10, characterised in that the passage (23) and the inner space (22) are located between the legs (26) of the first tubular element (18).

12. A tube arrangement according to claim 1, characterised in that a part (24b) of the peripheral surface of the first tubular element (18) and a part (25b) of the peripheral surface of the second tubular element (20) are adapted to form the outer peripheral surface of the tube arrangement when the first tubular element and the second tubular element are in a connected state.

13. A tube arrangement according to claim 12, characterised in that the outer area (24b) of the first tubular element (18) forms at least partly a convex outer surface of the tube arrangement (6) when the first tubular element (18) and the second tubular element (20) are in a connected state.

14. A tube arrangement according to claim 12, characterised in that the outer area (25b) of the second tubular element (20) forms at least partly a convex outer surface of the tube arrangement (6) when the first tubular element (18) and the second tubular element (20) are in a connected state.

15. A tube arrangement according to claim 12, characterised in that the outer area (24b) of the first tubular element (18) and the outer area (25b) of the second tubular element (20) have a design such that the tube arrangement (6) in a limit zone (28) between said areas (24b, 25b) obtains a smooth transition.

16. A tube arrangement according to claim 1, characterised in that the first tubular element (18) is manufactured of a material having elastic properties.

17. A tube arrangement according to claim 16, characterised in that the second tubular element (20) is manufactured of a material having elastic properties.

18. A tube arrangement according to claim 17, characterised in that the first tubular element (18) and the second tubular element (20) are manufactured of materials having different elastic properties.

19. A milking stall, characterised in that it comprises a tube arrangement according to claim 1.

20. A milking stall according to claim 19, wherein the milking stall comprises a milking member (3) attachable to an animal to be milked, characterised in that the tube arrangement (6) is connected to the milking member (3).

21. A milking stall according to claim 19, wherein the milking stall comprises a compact modular unit (1), characterised in that the tube arrangement (6) is connected to the compact modular unit (1).

22. A tube arrangement according to claim 1, characterised in that the first tubular element (18) and/or the second tubular element (20) comprise a passage (23) having an extension from a peripheral surface (24, 25) of the tubular element (18, 20) to an inner space (22) adapted to receive at least one conduit element (17).

23. A tube arrangement according to claim 1, characterised in that the second tubular element (20) is manufactured of a material having elastic properties.
